(19) United States
(12) Patent Application Publication
(10) Pub. No.: US 2014/0350914 A1
(43) Pub. Date: Nov. 27, 2014

(54) TERM TRANSLATION ACQUISITION METHOD AND TERM TRANSLATION ACQUISITION APPARATUS

(71) Applicants: Daniel Georg Andrade Silva, Tokyo (JP); Kai Ishikawa, Tokyo (JP); Masaaki Tsuchida, Tokyo (JP); Takashi Onishi, Tokyo (JP)

(72) Inventors: Daniel Georg Andrade Silva, Tokyo (JP); Kai Ishikawa, Tokyo (JP); Masaaki Tsuchida, Tokyo (JP); Takashi Onishi, Tokyo (JP)

(73) Assignee: NEC CORPORATION, Tokyo (JP)

(21) Appl. No.: 14/372,894

(22) PCT Filed: Jan. 27, 2012
(86) PCT No.: PCT/JP2012/052438

§ 371 Date: Jul. 17, 2014

(51) Int. Cl. G06F 17/28

(52) U.S. Cl. CPC G06F 17/289
USPC 704/2

(57) ABSTRACT

A term translation acquisition apparatus includes: a creation unit which creates a statistical model based on a set of input terms' context vectors, wherein the set of terms including at least two terms, are in the same source language and describe the same concept; and a ranking unit which uses the created statistical model to score terms in a target language that are considered as translation candidates for the concept.

### TECHNICAL FIELD

The present invention relates to a term translation acquisition method and a term translation acquisition apparatus.

### BACKGROUND ART

Automatic translation acquisition is an important task for various applications. For example, finding new term translations can be used to automatically update existing bilingual dictionaries, which are an indispensable resource for tasks as cross-lingual information retrieval and text mining. A term refers here to a single word, a compound noun, or a multiple word phrase.

Previous research suggests to use two comparable corpora resources which are stored in storage units 111A and 111B, respectively, as shown in FIG. 1. Comparable corpora are two text collections written in different languages, but which contain similar topics. The corpus stored in storage unit 111A is written in language A, and the corpus stored in storage unit 111B is written in language B. They do not need to be translations of each other, which makes them often readily available in contrast to parallel corpora. From the corpus stored in storage unit 111A context vectors are extracted for all relevant words written in language A, using extraction unit 120A. Similarly, from the corpus stored in storage unit 111B context vectors are extracted for all relevant words written in language B, using extraction unit 120B. Afterwards in mapping unit 130, the context vectors are mapped to a common vector space using a bilingual dictionary stored in storage unit 113. For example, in extraction units 120A and 120B, Non-Patent Document 1 creates context vectors where each dimension contains the tf-idf (term frequency-inverse document frequency) weight of a content word. Mapping unit 130 for example assumes a one-to-one translation of each content word, and neglects all words for which no translation in the bilingual dictionary is available. The possible translations of query term q written in language A (translation candidates (in language B) which are closest to query term q's context vector) are scored in ranking unit 140, and a ranked list of translation candidates are output to the user. Non-Patent Document 1 calculates in ranking unit 140 the similarity between the query term q and a translation candidate using the cosine similarity of their context vectors. However, the query term q might be ambiguous or might occur only infrequent in the corpus resource stored in storage unit 111A, which decreases the chance of finding the correct translation.

Non-Patent Document 2 suggests to use distance-based averaging to smooth the context vectors of a low-frequent query term q, using smoothing unit 125 as shown in FIG. 2. Using the corpus resource stored in storage unit 111A, a set of words, in the source language (language A), which are closest to query term q are determined. Let us denote this set of nearest neighbors as K. The context vector of each word in K is used to smooth the context vector of query term q by the following two steps. First a new context vector w is created, which is a weighted-average of the context vectors of the words in K. The weights are a function ƒ_{w} of the similarity to query term q's context vector. In the second step, this context vector w is used to smooth the context vector of query term q. In more detail, the context vector w is linearly combined with query term q's context vector, whereas the lower the frequency of word q, the higher the weight of the smoothing vector w.

### REFERENCES

Non-Patent Document 1: “A Statistical View on Bilingual Lexicon Extraction”, P. Fung, LNCS 1998
Non-Patent Document 2: “Finding Translations for Low-Frequency Words in Comparable Corpora”, V. Pekar, et. al, Machine Translation 2006

Previous solutions allow the user to input only one term which the system tries to translate. However, the context vector of one term does in general not reliably express one meaning, and therefore can result in poor translation accuracy.

In particular low-frequent words lead to sparse context vectors which contain unreliable correlation information to other terms. The problem of sparse context vectors is not addressed in Non-Patent Document 1. Non-Patent Document 2 suggests to use distance-based smoothing to overcome the problem of a low-frequent query's sparse context vector. Source words which context vectors are similar to the query's context vector are assumed to be also similar in the meaning intended by the user. However, words which are used in similar context are related in meaning, but not necessarily similar in meaning. For example using a corpus about automobiles we found that [symbol] [jishaku] (“magnet”)'s most similar word is [symbol] [setchaku] (“adhesion”), with respect to their context vectors. Herein, a word enclosed by [ ] is a romanized spelling of a Japanese word that is placed immediately before that word. For example, the phrase” [symbol] [jishaku]” means that the word “jishaku” is a romanized spelling of the Japanese word “ [symbol] ”. And as a consequence, Non-Patent Document 2's method will smooth the context vector of [symbol] [jishaku] (“magnet”) using [symbol] [setchalcu] (“adhesion”)'s context vector. But the user's intended meaning is obviously better supported by a word like [symbol] [symbol] [magunetto] (“magnet”). Even worse, the lower the frequency of [symbol] [jishaku] (“magnet”), the more weight will be given to [symbol] [setchakti] (“adhesion”)'s context vector and [symbol] [jishaku] (“magnet”)'s context vector will be neglected. This inevitably leads to a decrease in translation accuracy.

Another reason why the context vector of one query term does in general not reliably express one meaning is that the query word can be ambiguous. An ambiguous word's context vector, which contains correlation information related to different senses, leads to correlation information which can be difficult to compare across languages. The user might for example input the ambiguous word [symbol] [ftido] (“food” or “hood”). The resulting context vector will be noisy, since it contains the context information of both meanings, “food” and “hood”, which will lead to lower translation accuracy. This problem is neither addressed by Non-Patent Document 1, nor Non-Patent Document 2.

The problem of a single term's unreliable context vector is addressed by the following invention.

### DISCLOSURE OF INVENTION

An exemplary object of the present invention is to provide a term translation acquisition method and a term translation acquisition apparatus that solve the aforementioned problems.

An exemplary aspect of the present invention is a term translation acquisition apparatus which includes: a creation unit which creates a statistical model based on a set of input terms' context vectors, wherein the set of terms, including at least two terms, are in the same source language and describe the same concept; and a ranking unit which uses the created statistical model to score terms in a target language that are considered as translation candidates for the concept.

Another exemplary aspect of the present invention is a term translation acquisition method which includes: creating a statistical model based on a set of input terms' context vectors, wherein the set of terms, including at least two terms, are in the same source language and describe the same concept; and using the created statistical model to score terms in a target language that are considered as translation candidates for the concept.

Yet another exemplary aspect of the present invention is a computer-readable recording medium storing a program that causes a computer to execute: a creation function of creating a statistical model based on a set of input terms' context vectors, wherein the set of terms, including at least two terms, are in the same source language and describe the same concept; and a ranking function of using the created statistical model to score terms in a target language that are considered as translation candidates for the concept.

According to the present invention, the problem of sparse context vectors related to low-frequent terms. as well as the problem of noisy context vectors related to ambiguity of input terms can be mitigated. As a consequence, translation accuracy is improved.

### BRIEF DESCRIPTION OF DRAWINGS

FIG. 1 is a block diagram showing the functional structure of the term translation system related to Non-Patent Document 1.

FIG. 2 is a block diagram showing the functional structure of the term translation system related to Non-Patent Document 2.

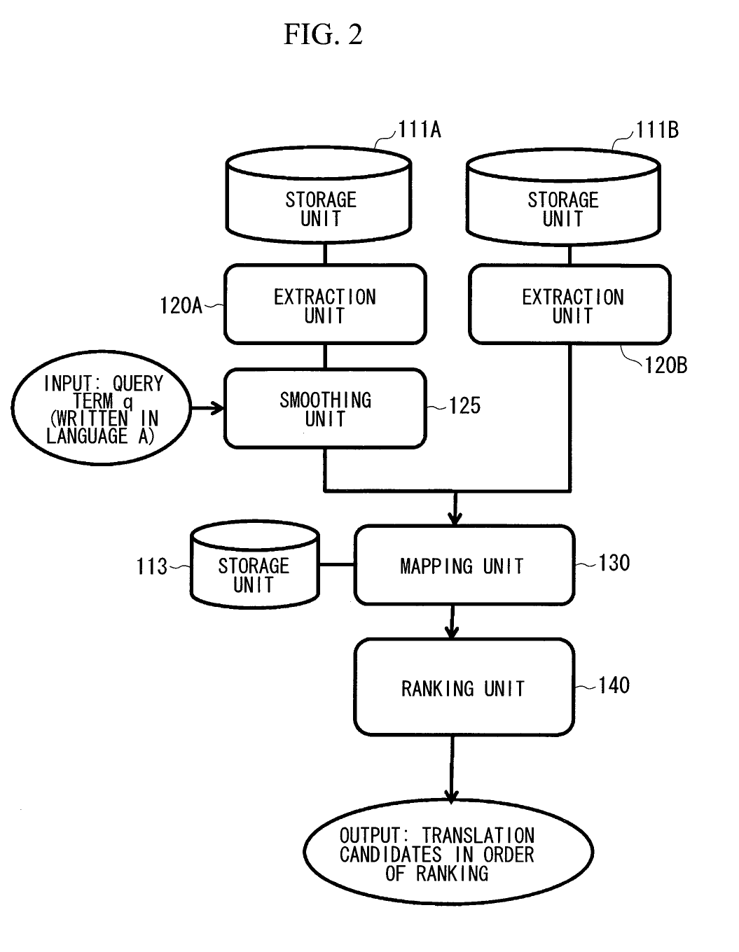

FIG. 3 is a block diagram showing the functional structure of a term translation acquisition apparatus (a term translation system) according to a first exemplary embodiment of the present invention.

FIG. 4 is a block diagram showing the functional structure of a term translation acquisition apparatus (a term translation system) according to a second exemplary embodiment of the present invention.

FIGS. 5A and 5B are explanatory diagrams showing the processing of the query term [symbol] [jishaku] (“magnet”) by distance-based smoothing.

FIGS. 6A to 6C are explanatory diagrams showing the processing of the query terms [symbol] [jishaku] (“magnet”) and [symbol] [magunetto] (“magnet”) by the term translation acquisition apparatus according to the exemplary embodiments of the present invention.

FIGS. 7A and 7C are explanatory diagrams showing the processing of the query term [symbol] [ffido] (“food” or “hood”) and [symbol] [bonnetto] (“hood”, “hat”) by the term translation acquisition apparatus according to the exemplary embodiments of the present invention.

### BEST MODE FOR CARRYING OUT THE INVENTION

### First Exemplary Embodiment

A first exemplary embodiment of the present invention will be described hereinafter by referring to the drawings.

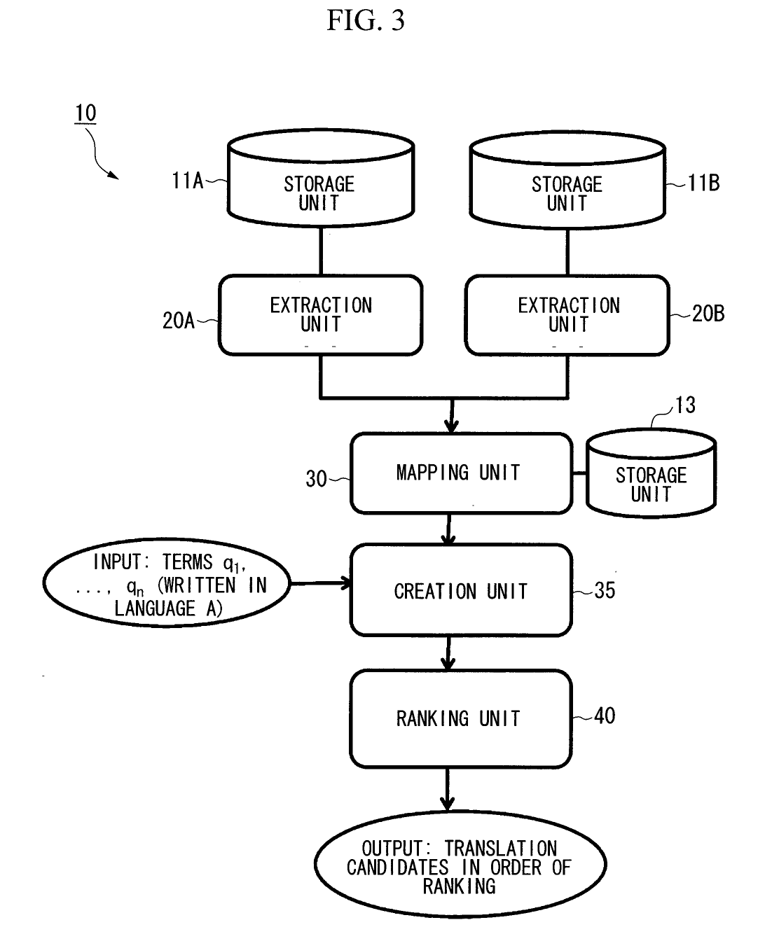

Term translation acquisition apparatus 10 (term translation system) according to the present exemplary embodiment includes storage unit 11A, storage unit 11B, storage unit 13, extraction unit 20A, extraction unit 20B, mapping unit 30, creation unit 35, and ranking unit 40, as shown in FIG. 3. Term translation acquisition apparatus 10 uses two corpora stored in storage units 11A and 11B. The two corpora can be, for example, two text collections written in different languages, but which contain similar topics. The corpus stored in storage unit 11A is written in language A (a source language), and the corpus stored in storage unit 11B is written in language B (a target language). Herein, the source language is Japanese and the target language is English, but the source language and the target languages are not limited to these languages. From the corpus stored in storage unit 11A, term translation acquisition apparatus 10 extracts context vectors for all relevant terms written in language A, using extraction unit 20A. Similarly, from the corpus stored in storage unit 11B, term translation acquisition apparatus 10 extracts context vectors for all relevant terms written in language B, using extraction unit 20B. Afterwards, in mapping unit 30, the context vectors are mapped to a common vector space using a bilingual dictionary stored in storage unit 13. Extraction unit 20A for example creates context vectors for all nouns which occur in the corpus resource stored in storage unit 11A, where each dimension of these context vectors contains the tf-idf weight of a content word in Japanese. Similar, extraction unit 20B does the same for all possible translation candidates, or all terms, in the target language extracted from the corpus resource stored in storage unit 11B. For example. it creates the context vector for all English nouns, like “magnet” and “car”, whereas each dimension contains the correlation to a content word in English. In mapping unit 30 the context vectors for the Japanese terms and the English terms are made comparable by consulting the bilingual dictionary stored in storage unit 13. Mapping unit 30 for example assumes a one-to-one translation of each content word, and neglects all words for which no translation in the bilingual dictionary is available. The resulting context vectors in Japanese and English are then passed to creation unit 35.

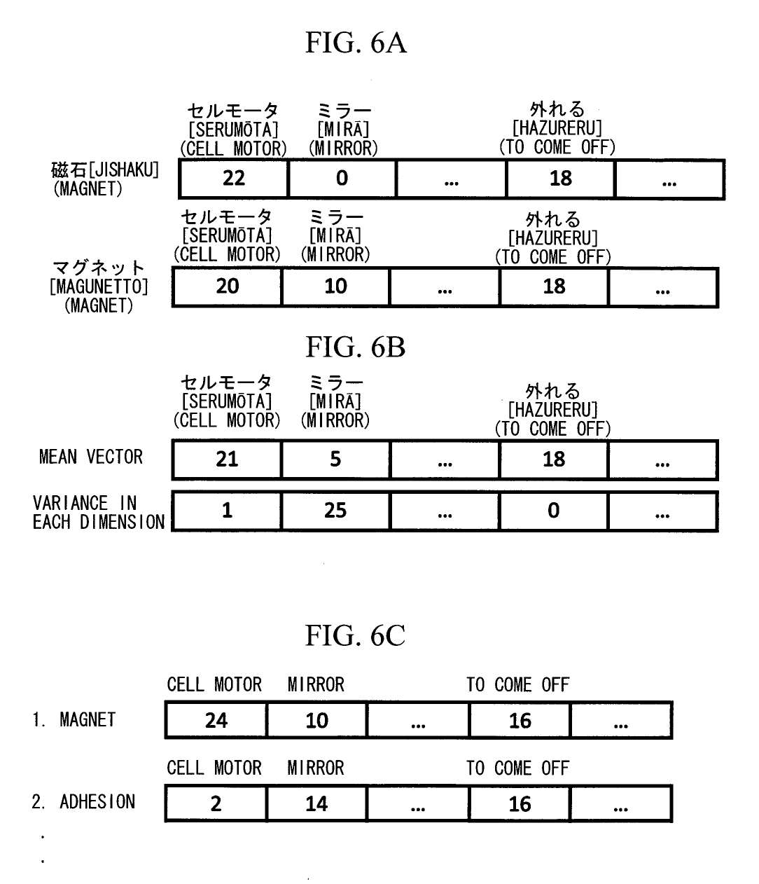

The user formulates a translation query by using a set of terms (terms q₁, . . . , qₙ, where n is a natural number greater than or equal to 2) which are the input of creation unit 35. Creation unit 35 uses the context vectors corresponding to each input term in order to create a statistical model C. For example, the user might input the synonyms [symbol] [jishaku] (“magnet”) and [symbol] [magunetto] (“magnet”). The corresponding context vectors are shown in FIG. 6A. The context [symbol] [serumota] (“cell motor”) and [symbol] [hazureru] (“to come off”) are important contexts shared by both [symbol] [symbol] [jishakti] (“magnet”) and [symbol] [magunetto] (“magnet”), and is therefore also expected to be an important context of the correct translation “magnet”. On the other hand, the importance of [symbol] [mirā] (“mirror”) is indecisive; it has a low weight, 0, for [symbol] [jishaku] (“magnet”), but a high weight, 10, for [symbol] [magunetto] (“magnet”). Therefore the context of “mirror” is uncertain to be also important for the correct translation “magnet”. Important and unimportant contexts are inferred from the mean and variance in the corresponding dimension. For example, the important context [symbol] [serumōta] (“cell motor”), and the relatively unimportant context [symbol] [mirā] (“mirror”) have low and high variance, respectively. Using the statistics of mean and covariance matrix, an appropriate statistical model is created in creation unit 35. For example, creation unit 35 creates the model with statistics shown in FIG. 6B.

The created statistical model is then used in ranking unit 40 to score terms in the target language (translation candidates in language B). For example, as shown in FIG. 6C, ranking unit 40 ranks translation candidates according to the similarity to the created model. Target language terms which are likely given the created statistical model, are assumed to be likely translation candidates. The model can differentiate between relatively important and unimportant context that describes the meaning of “magnet” of the term [symbol] [jishaku]. Therefore, the correct translation “magnet” is scored higher than other, incorrect, translations (e.g., “adhesion”) (see FIG. 6C).

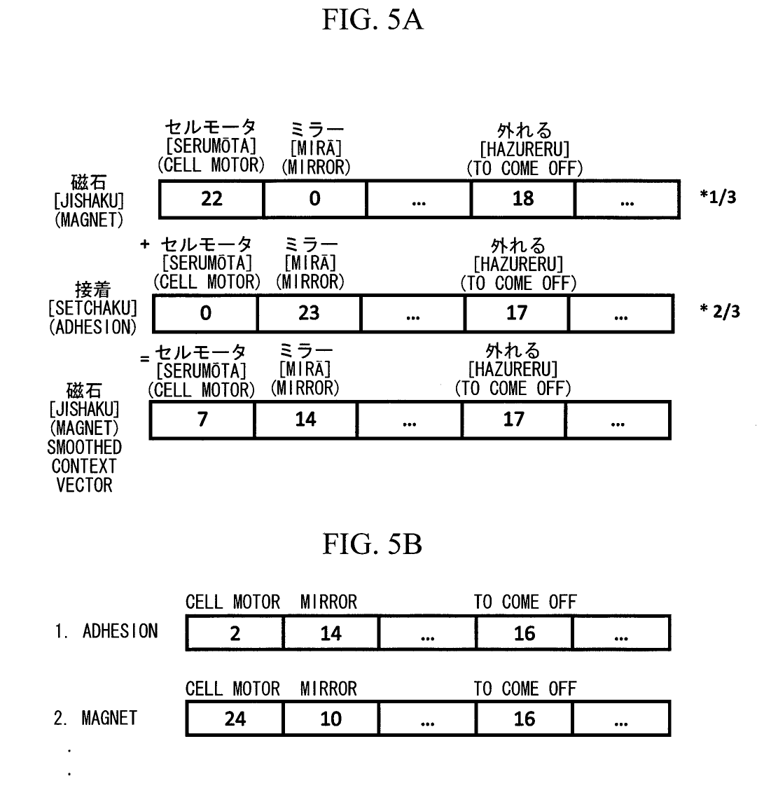

In contrast, a distance-based smoothing approach, like Non-Patent Document 2, can suffer when smoothing with words which are not synonyms. In Non-Patent Document 2, the user can input only one term, here [symbol] [jishaku] (“magnet”). In the source language, the context vector of [symbol] [setchaku] (“adhesion”) is most similar to [symbol] [symbol] [jishaku] (“magnet”)'s context vector, and will therefore be used for smoothing (see FIG. 5A). Assuming that [symbol] [setchaku] (“adhesion”) is more frequent than [symbol] [jishaku] (“magnet”), the context vector of [symbol] [setchaku] (“adhesion”) will be higher weighted than the one of [symbol] [jishaku] (“magnet”), when combined to a smoothed context vector. In the example depicted in FIG. 5A, the weights are ⅓ for [symbol] [jishaku] (“magnet”) and ⅔ for [symbol] [setchaku] (“adhesion”). The smoothed context vector is then used to find the most similar English terms which are assumed to be translations of [symbol] [jishaku] (“magnet”). As shown in FIG. 5B, translation candidates are ranked according to the similarity to the smoothed context vector. However, since the smoothed context vector is dominated by the context of [symbol] [setchaku] (“adhesion”), the result is that the English word “adhesion” will be higher ranked than the correct translation “magnet”.

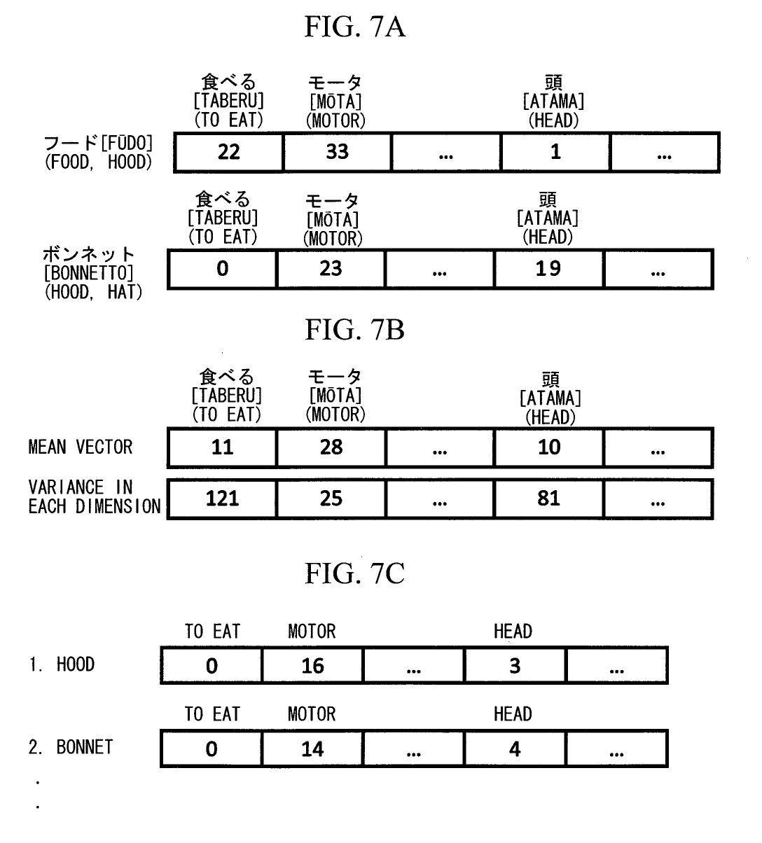

Another example of the present exemplary embodiment is given in FIGS. 7A to 7C. Assuming the user inputs the two ambiguous terms [symbol] [fliclo] (“food” or “hood”) and [symbol] [bonnetto] (“hood” or “hat”), which describe the concept “hood”. Term translation acquisition apparatus 10 will automatically focus on the common meaning “hood”, by enforcing common parts of the context vectors and relaxing diverging parts of the context vectors. The enforcing and relaxation is reflected here by low and high variance, respectively. For example, the context [symbol] [taberu] (“to eat”) is related to the meaning of “food” of [symbol] [fūdo] (“food” or “hood”), and is not important for any meaning of [symbol] [bonnetto] (“hood” or “hat”). As a consequence the variance in the dimension [symbol] [taberu] (“to eat”) is high, as shown in FIG. 7B. On the other hand, [symbol] [flido] (“food” or “hood”) and [symbol] [bonnetto] (“hood” or “hat”) share the context [symbol] [mōta] (“motor”), resulting in a relatively low variance in that dimension, as shown in FIG. 7B. The statistical model considers these differences in variance, when comparing the created statistical model to the context vectors of possible translation candidates, in ranking unit 40.

In particular, for creation unit 35 and ranking unit 40 the following approach can be used. Let us assume that the input terms are distributed according to a von Mises distribution with parameter tn. This is motivated by the fact that in practice the cosine similarity is one of the methods which are best suited for comparing context vectors. The cosine-similarity measures the angle between two vectors, and the von Mises distribution defines a probability distribution over the possible angles. The parameter in of the von Mises distribution is calculated as follows: Given the query words q₁, . . . , qₙ, the corresponding context vectors are denoted as v₁, . . . , vₙ. Then the mean vector r is calculated as:

$$r = {\sum }_{i = 1}^{n} \frac{{v}_{i}}{n} \qquad ( 1 )$$

The parameter m is the L2-normalized vector of r, i.e.:

$$m = \frac{r}{\sqrt{r \cdot {r}^{T}}} \qquad ( 2 )$$

In ranking unit 40, the translation candidates are determined by finding the words (in language B) which are closest to the statistical model C defined above. The similarity of a word, with context vector x, to a cluster defined by a von Mises distribution with parameter in, can be set to p(x|C). The conditional probability p(x|C) is calculated as follows:

p(x|C)∝x·m^{T} (3)

assuming in and x are normalized row vectors. Additionally a covariance matrix or any positive-definite matrix A can be used to express different importance of context terms and correlation between context terms:

p(x|C)∝x·A·m^{T} (4)

In general, any other statistical model can be used for C.

Scoring a translation candidate according to p(x|C) is not the only choice. Ranking unit 40 can alternatively score a translation candidate x according to the posterior distribution of C, i.e. p(C|x). This can be achieved by defining an appropriate prior distribution p(x), since

$$p ( c \vert x ) ∝ \frac{p ( x \vert C )}{p ( x )} \qquad ( 5 )$$

Note that p(C) can be considered as a constant since, ranking unit 40 compares one constant set of terms (described by C) with several different translation candidates. The prior distribution p(x) can, for example, incorporate knowledge about the frequency of translation candidate x or whether a translation of x is already available or not. For example, the noun “car” is less likely to be a translation candidate of a Japanese word which is not listed in a large-sized bilingual dictionary, than an English word not listed in the dictionary.

As described above, the present exemplary embodiment uses the multiple terms' context vector in order to emphasize the important context, and this way reducing the impact of an unreliable single context vector's noise.

The present exemplary embodiment can overcome the context vector's unreliability by allowing the user to input multiple terms, which are similar or related in meaning. That is, the input terms describe a certain concept, in particular this can be, but is not limited to a set of synonyms. This is motivated by the fact that it is often possible to specify additional terms with similar meanings. For example, additionally to the term [symbol] [jishaku] (“magnet”), the user can input [symbol] [magunetto] (“magnet”). In the same way, additionally to the term [symbol] [fũdo] (“food” or “hood”), the user can input either [symbol] [tabemono] (“food”) or [symbol] [bonnetto] (“hood”, “hat”), depending on the user's intended meaning. The multiple input query terms' context vectors are used by the statistical model to emphasize the common context parts, and neglect the uncommon context parts. With this way, the problem of sparse context vectors, as well as the problem of noisy context vectors related to ambiguity can be mitigated. As a consequence, the present exemplary embodiment leads to improved translation accuracy.

### Second Exemplary Embodiment

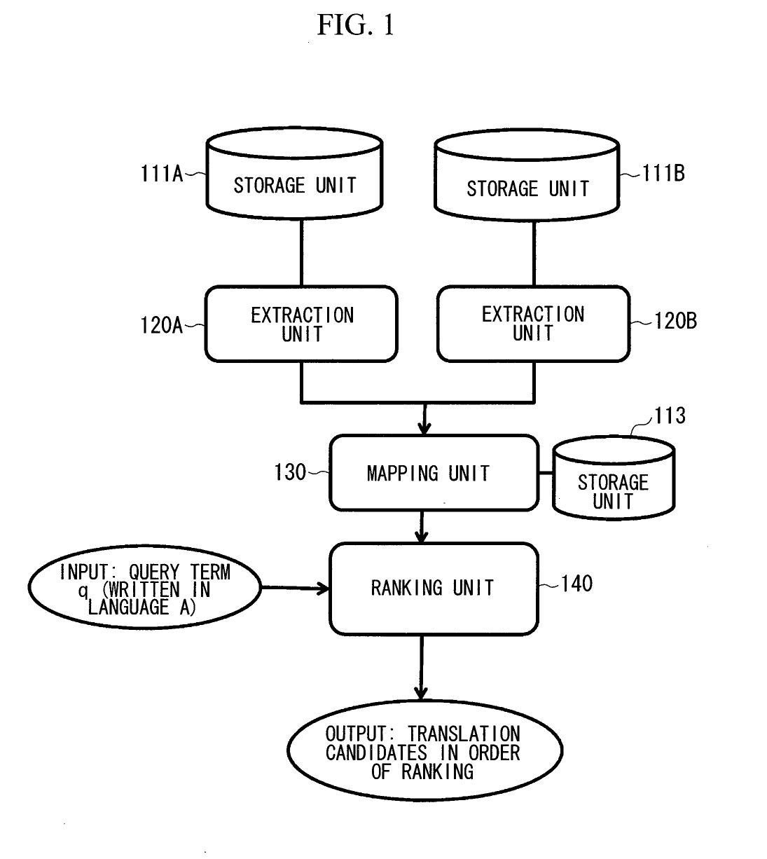

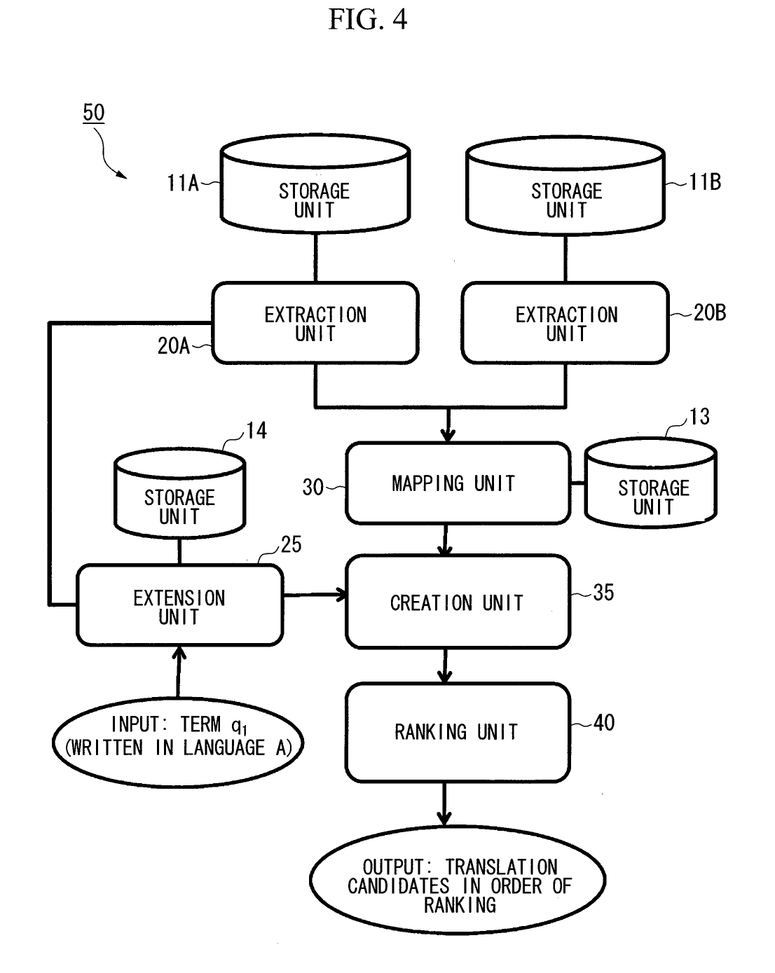

Term translation acquisition apparatus 50 (term translation system) according to a second exemplary embodiment of the present invention will be described hereinafter by referring to FIG. 4. In FIG. 4, the same reference numerals are assigned to components similar to those shown in FIG. 1, and a detailed description thereof is omitted here. Term translation acquisition apparatus 50 further includes storage unit 14 which stores a monolingual dictionary (e.g., a thesaurus) and extension unit 25.

In this setting the user inputs one term q₁ which is to be translated. In extension unit 25, the single input term q₁ is extended to a set of input terms q₁, . . . , qₙ, containing at least two terms, in the following way. First, a set of terms which are synonymous to the input term are looked up in the monolingual dictionary stored in storage unit 14. Second, using the context information obtained from the source corpus, which is stored in storage unit 11A, extension unit 25 determines, among these synonymous terms, the most appropriate terms, named q₂, . . . , qₙ. That is, extension unit 25 selects terms q₂, . . . , qₙ which are similar to the term q₁. For determining whether a synonymous term is appropriate or not, extension unit 25 calculates the similarity between the context vector of term q₁ and the synonymous term's context vector.

Finally, the extended input set of terms q₁, . . . , qₙ is passed to creation unit 35, where the processing is analogously to the way described in the First Exemplary Embodiment.

In the first exemplary embodiment the user had to specify two terms [symbol] [jishaku] (“magnet”) and [symbol] [magunetto] (“magnet”), and term translation acquisition apparatus 10 used both terms to overcome the problem related to unreliable context vectors. Here the present exemplary embodiment assumes that the user inputs only [symbol] [jishaku] (“magnet”), and the thesaurus stored in storage unit 14 suggests the synonyms [symbol] [kompasu] (“compass”) and [symbol] [magunetto] (“magnet”). Extension unit 25 calculates the similarity between [symbol] [jishaku] (“magnet”)'s context vector and each of its synonyms' context vector. Similarity of two context vectors can be calculated with the cosine similarity. The present exemplary embodiment assumes that [symbol] [jishaku] (“magnet”)'s context vector is more similar to [symbol] [magunetto] (“magnet”)'s context vector than to [symbol] [kompasu] (“compass”)'s context vector. Therefore extension unit 25 neglects [symbol] [kompasu] (“compass”), and uses only [symbol] [magunetto] (“magnet”) to extend the input set. The input set, containing [symbol] [jishaku] (“magnet”) and [symbol] [magunetto] (“magnet”), is then passed to creation unit 35.

As described above, the present exemplary embodiment provides an exemplary advantage that the user does not have to specify multiple terms, in addition to the same exemplary advantages as those of the first exemplary embodiment.

While the present invention has been particularly shown and described with reference to exemplary embodiments thereof, the present invention is not limited to those exemplary embodiments. It will be understood by those of ordinary skill in the art that various changes in form and details may be made therein without departing from the spirit and scope of the present invention as defined in the claims.

For example, a program for realizing the respective processes of the exemplary embodiments described above may be recorded on a computer-readable recording medium, and the program recorded on the recording medium may be read on a computer system and executed by the computer system to perform the above-described processes related to the term translation acquisition apparatuses.

The computer system referred to herein may include an operating system (OS) and hardware such as peripheral devices. In addition, the computer system may include a homepage providing environment (or displaying environment) when a World Wide Web (WWW) system is used.

The computer-readable recording medium refers to a storage device, including a flexible disk, a magneto-optical disk, a read only memory (ROM), a writable nonvolatile memory such as a flash memory, a portable medium such as a compact disk (CD)-ROM, and a hard disk embedded in the computer system. Furthermore, the computer-readable recording medium may include a medium that holds a program for a constant period of time, like a volatile memory (e.g., dynamic random access memory; DRAM) inside a computer system serving as a server or a client when the program is transmitted via a network such as the Internet or a communication line such as a telephone line.

The foregoing program may be transmitted from a computer system which stores this program to another computer system via a transmission medium or by a transmission wave in a transmission medium. Here, the transmission medium refers to a medium having a function of transmitting information, such as a network (communication network) like the Internet or a communication circuit (communication line) like a telephone line. Moreover, the foregoing program may be a program for realizing some of the above-described processes. Furthermore, the foregoing program may be a program, i.e., a so-called differential file (differential program), capable of realizing the above-described processes through a combination with a program previously recorded in a computer system.

### INDUSTRIAL APPLICABILITY

The present invention assists the translation of a concept by allowing the user to describe the concept by a set of related terms. In particular, it allows the user to include spelling variations and other synonymous expressions to find translations of terms with low-frequency or ambiguity.

Alternatively, the user's input can be automatically expanded. For example, a user might input only one term, and then, plausible spelling variations can be automatically generated, to create a set of related terms. In addition, the user's input set of terms can be automatically extended by using available monolingual resources like thesauri.

Another application is to assist cross-lingual thesauri mapping. In that setting the set of terms in a subtree of a hierarchically structured thesaurus are considered as input. The input describes a certain hypernym which can then be translated using the present invention.

1. A term translation acquisition apparatus comprising:
a creation unit which creates a statistical model based on a set of input terms' context vectors, wherein the set of terms, including at least two terms, are in the same source language and describe the same concept; and
a ranking unit which uses the created statistical model to score terms in a target language that are considered as translation candidates for the concept.

2. The apparatus according to claim 1, wherein the creation unit creates the statistical model using a covariance matrix and a mean vector of the input terms' context vectors.

3. The apparatus according to claim 1, wherein the ranking unit scores each translation candidate in the target language according to the created statistical model using similarity between each translation candidate and the statistical model.

4. The apparatus according to claim 3, wherein the ranking unit uses, as the similarity, the probability that each translation candidate is observed given the created statistical model.

5. The apparatus according to claim 3, wherein the ranking unit uses, as the similarity, the posterior probability of a statistical model's parameter assuming a prior distribution over each translation candidate.

6. The apparatus according to claim 1, wherein a user's input includes a single term in the source language, and
the apparatus further comprises an extension unit which extends the single input term to the set of input terms, including at least two terms, and supplies the extended set of input terms to the creation unit.

7. The apparatus according to claim 6, wherein the extension unit comprises a storage unit which stores a monolingual dictionary including synonymous terms in the source language, and
the extension unit looks up synonyms which are a set of terms which are synonymous to the single input term in the monolingual dictionary, selects, among the looked up synonyms, terms which context vector is closer to the single input term's context vector than context vectors of the other terms, and supplies the selected terms and the single input term to the creation unit as the set of input terms.

8. A term translation acquisition method comprising:
creating a statistical model based on a set of input terms' context vectors, wherein the set of terms, including at least two terms, are in the same source language and describe the same concept; and
using the created statistical model to score terms in a target language that are considered as translation candidates for the concept.

9. A computer-readable recording medium storing a program that causes a computer to execute:
a creation function of creating a statistical model based on a set of input terms' context vectors, wherein the set of terms, including at least two terms, are in the same source language and describe the same concept; and
a ranking function of using the created statistical model to score terms in a target language that are considered as translation candidates for the concept.

10. The apparatus according to claim 2, wherein the ranking unit scores each translation candidate in the target language according to the created statistical model using similarity between each translation candidate and the statistical model.

11. The apparatus according to claim 10, wherein the ranking unit uses, as the similarity, the probability that each translation candidate is observed given the created statistical model.

12. The apparatus according to claim 10, wherein the ranking unit uses, as the similarity, the posterior probability of a statistical model's parameter assuming a prior distribution over each translation candidate.

13. The apparatus according to claim 2, wherein a user's input includes a single term in the source language, and
the apparatus further comprises an extension unit which extends the single input term to the set of input terms, including at least two terms, and supplies the extended set of input terms to the creation unit.

14. The apparatus according to claim 13, wherein the extension unit comprises a storage unit which stores a monolingual dictionary including synonymous terms in the source language, and
the extension unit looks up synonyms which are a set of terms which are synonymous to the single input term in the monolingual dictionary, selects, among the looked up synonyms, terms which context vector is closer to the single input term's context vector than context vectors of the other terms, and supplies the selected terms and the single input term to the creation unit as the set of input terms.

15. The apparatus according to claim 3, wherein a user's input includes a single term in the source language, and
the apparatus further comprises an extension unit which extends the single input term to the set of input terms, including at least two terms, and supplies the extended set of input terms to the creation unit.

16. The apparatus according to claim 15, wherein the extension unit comprises a storage unit which stores a monolingual dictionary including synonymous terms in the source language, and
the extension unit looks up synonyms which are a set of terms which are synonymous to the single input term in the monolingual dictionary, selects, among the looked up synonyms, terms which context vector is closer to the single input term's context vector than context vectors of the other terms, and supplies the selected terms and the single input term to the creation unit as the set of input terms.

17. The apparatus according to claim 10, wherein a user's input includes a single term in the source language, and
the apparatus further comprises an extension unit which extends the single input term to the set of input terms, including at least two terms, and supplies the extended set of input terms to the creation unit.

18. The apparatus according to claim 17, wherein the extension unit comprises a storage unit which stores a monolingual dictionary including synonymous terms in the source language, and
the extension unit looks up synonyms which are a set of terms which are synonymous to the single input term in the monolingual dictionary, selects, among the looked up synonyms, terms which context vector is closer to the single input term's context vector than context vectors of the other terms, and supplies the selected terms and the single input term to the creation unit as the set of input terms.

19. The apparatus according to claim 4, wherein a user's input includes a single term in the source language, and
the apparatus further comprises an extension unit which extends the single input term to the set of input terms, including at least two terms, and supplies the extended set of input terms to the creation unit.

20. The apparatus according to claim 5, wherein a user's input includes a single term in the source language, and
the apparatus further comprises an extension unit which extends the single input term to the set of input terms, including at least two terms, and supplies the extended set of input terms to the creation unit.
